(19) United States
(12) Patent Application Publication
(10) Pub. No.: US 2023/0037449 A1
(43) Pub. Date: Feb. 9, 2023

(54) ARTICLES, DIES AND METHODS OF MAKING THE SAME

(71) Applicant: 3M INNOVATIVE PROPERTIES COMPANY, St. Paul, MN (US)

(72) Inventors: Robert T. Krasa, Hudson, WI (US); James J. Kobe, Newport, MN (US); Becky A. Jetto, Jordan, MN (US); Dedra V. Dunevant, Woodbury, MN (US); Ronald W. Ausen, St. Paul, MN (US); William J. Kopecky, Hudson, WI (US); Ramasubramani Kuduva Raman Thanumoorthy, Woodbury, MN (US)

(21) Appl. No.: 17/787,463

(22) PCT Filed: Dec. 16, 2020
(86) PCT No.: PCT/IB2020/062067

§ 371 Date: Jun. 20, 2022

Related U.S. Application Data
(60) Provisional application No. 62/952,613, filed on Dec. 23, 2019.

(51) Int. Cl. B32B 3/26; B32B 5/18; B29C 44/50; B29C 44/34; B29C 44/56; B29C 44/24; B29C 48/305; C09J 7/38; C09J 7/29

(52) U.S. Cl. CPC B32B 3/266; B32B 5/18; B29C 44/505; B29C 44/3415; B29C 44/56; B29C 44/24; B29C 48/307; C09J 7/38; C09J 7/29; B32B 2307/732; B32B 2266/0207; B32B 2405/00; B32B 2266/08; B29K 2105/046

(57) ABSTRACT

Pressure sensitive adhesive-coated articles comprising first and second layers each having first and second opposed major surfaces and between the first and second layers a series of first walls providing a series of microchannels, and methods for making the same. Embodiment of articles described herein are useful, for example, in cushioning applications where high levels of compression are desired.

### BACKGROUND

Extrusion of channel prof are well known in the art. Typically, single or two-piece dies are constructed to generate the channel profile (see, e.g., U.S. Pat. No. 3,274,315 (Kawamura). A typical extrusion die may have an outer manifold and an inner manifold. The inner manifold includes a port for allowing air to enter within the channel as the extrusion is formed, which prevents the collapse of the channel structure. Machining of these dies is limited to the precision at which die parts can be formed.

The extrusion of smaller channels to form film-like webs typically requires higher precision extrusion dies. This is because the flow rate of material is very dependent upon the resistance within the die. Small changes in the cavity size have significant effects on the resultant extruded part. Thus, uniformity of flow passageway resistance within the die is important for the formation of uniform channel webs.

Coextrusion of polymers is well known in the art. Polymer melt streams from two or more extruders are combined together to form articles with unique properties. Successful coextrusion is dependent upon polymer weld lines to hold together based on the needs of the article. The compatibility of coextruded polymers and the methods of welding the streams together are important considerations for the article construction.

Channel webs are useful for many applications such as spacer webs and cushioning materials. There is a need to create thin channel webs which are uniform in mechanical properties.

### SUMMARY

In one aspect, the present disclosure describes a first article comprising first and second opposed major surfaces, the first coextruded article comprising:

a layer having first and second opposed major surfaces, wherein the first major surface of the layer and the first major surface of the first coextruded article are the same major surface, and wherein the first layer comprises a first material;

a series of first walls providing a series of microchannels extending from the second major surface of the layer and each wall having a distal end with a major surface, wherein the first walls comprise a second material, wherein there are at least 3 (in some embodiments, at least 3, 5, 10, 15, 20, 25, 30, 35, or even up to 40) first walls per cm, wherein there is an average minimum width for the first walls, and wherein the minimum width of an individual first wall is within ±25 (in some embodiments, ±20, ±15, ±10, or even ±5) percent of the average minimum width for the first walls;

segments comprising a third material, wherein one of the segments is position between two adjacent first walls, wherein the segments have first and second opposed major surfaces, and wherein the second major surface of the segments, the second major surface of the coextruded article, and the major surface of the distal ends of the walls are the same major surfaces;

and, a layer of pressure sensitive adhesive adjacent the first major surface of the coextruded article.

In another aspect, the present disclosure describes a method of making first articles described herein, the method comprising:

providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims;

providing via extrusion a first material to the first cavity of the extrusion die, a second material to the second cavity of the extrusion die, and a third material to the third cavity of the extrusion die;

extruding the layer from the distal opening of the die slot; and

quenching the extruded layer.

In another aspect, the present disclosure describes a second article comprising first and second opposed major surfaces, the second coextruded article comprising:

a layer having first and second opposed major surfaces, wherein the first major surface of the layer and the first major surface of the second coextruded article are the same major surface, and wherein the first layer comprises a first material;

a series of first walls provide a series of microchannels extending from the second major surface of the layer and each wall having a distal end with a major surface, wherein the first walls comprise a second material, wherein the first layer comprises first segments, wherein each segment being connected to a single wall, wherein there is a line of demarcation line between adjacent segments, and wherein there are at least 10 (in some embodiments, at least 15, 20, 25, 30, 35, or even up to 40) first walls per cm; and

second segments comprising a third material, wherein one of the second segments is positioned between two adjacent first walls, wherein the second segments have first and second opposed major surfaces, and wherein the second major surface of the second segments, the second major surface of the coextruded article, and the major surface of the distal ends of the walls are the same major surfaces; and,

adhesive layers sandwiching the layer.

In another aspect, the present disclosure describes a method of making second coextruded articles described herein, the method comprising:

providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims; wherein together these shims form a repeating orifice pattern of shims;

providing via extrusion a first material to the first cavity of the extrusion die, a second material to the second cavity of the extrusion die, and a third material to the third cavity of the extrusion die;

extruding the layer from the distal opening of the die slot;

quenching the extruded layer; and,

coating an adhesive on at least one major side of the extruded layer.

In another aspect, the present disclosure describes a third coextruded article comprising first and second opposed major surfaces, the third coextruded article comprising:

a layer having first and second opposed major surfaces, wherein the first major surface of the layer and the first major surface of the third article are the same major surface, and wherein the first layer comprises a first material;

a series of first walls provide a series of microchannels extending from the second major surface of the layer and each wall having a distal end with a major surface, wherein the first walls comprise a second material, wherein there are at least 10 (in some embodiments, at least 15, 20, 25, 30, 35, or even up to 40) first walls per cm; and

segments comprising a third material, wherein one of the segments is positioned between two adjacent first walls, wherein the segments have first and second opposed major surfaces, and wherein the second major surface of the segments, the second major surface of the coextruded article, and the major surface of the distal ends of the walls are the same major surfaces, wherein the third material is different from the second material.

In another aspect, the present disclosure describes a method of making third coextruded articles described herein, the method comprising:

providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims; wherein together these shims form a repeating orifice pattern of shims;

providing via extrusion a first material to the first cavity of the extrusion die, a second material to the second cavity of the extrusion die, and a third material to the third cavity of the extrusion die;

extruding the layer from the distal opening of the die slot;

quenching the extruded layer; and,

coating at least one major side of the extruded layer with an adhesive.

Embodiment of coextruded articles described herein are useful, for example, in cushioning applications where high levels of compression are desired. Conventional foamed sheets are typically limited in the amount of void space that can be generated, whereas embodiments of coextruded articles described herein can have relatively high void content (i.e., greater than 50%).

Embodiments of coextruded articles described herein are useful, for example, in applications using liquid or gas materials for heat transfer. For example, a coextruded article described herein can be placed in contact with components requiring temperature control, wherein the channels contain heat transfer media.

Embodiments of coextruded articles described herein may also be used as spacer webs. For example, coextruded articles described herein can provide significant spacing with a minimal amount of material usage. For example, coextruded articles which require beam strength with minimal weight can be created with rigid films separated by a coextruded article described herein.

### BRIEF DESCRIPTION OF THE DRAWINGS

FIG. 1 is a schematic cross-sectional view of an exemplary first coextruded article described herein.

FIG. 2A is a schematic cross-sectional view of an exemplary second coextruded article described herein.

FIG. 2B is a schematic cross-section view of another exemplary second coextruded article showing analytical regions for demarcation line detection.

FIG. 3 is a schematic cross-sectional view of an exemplary third coextruded article described herein.

FIG. 4 is a schematic cross-sectional view of an exemplary die cavity pattern just upstream from the dispensing slot of the die employed in the formation of an exemplary polymeric coextruded article described herein.

FIG. 5A is a plan view of an exemplary embodiment of a shim suited to form a sequence of shims capable of forming an exemplary coextruded polymeric article, for example, as shown in the schematic cross-sectional views of FIGS. 1, 2, and 3.

FIG. 5B is an expanded region near the dispensing surface of the shim shown in FIG. 5A.

FIG. 6A is a plan view of an exemplary embodiment of a shim suited to form a sequence of shims capable of forming a coextruded polymeric article, for example, as shown in the schematic cross-sectional views of FIGS. 1, 2, and 3.

FIG. 6B is an expanded region near the dispensing surface of the shim shown in FIG. 6A.

FIG. 7A is a plan view of an exemplary embodiment of a shim suited to form a sequence of shims capable of forming a coextruded polymeric article, for example, as shown in the schematic cross-sectional views of FIGS. 1, 2, and 3.

FIG. 7B is an expanded region near the dispensing surface of the shim shown in FIG. 7A.

FIG. 8A is a plan view of an exemplary embodiment of a shim suited to form a sequence of shims capable of forming a coextruded polymeric article, for example, as shown in the schematic cross-sectional views of FIGS. 1, 2, and 3.

FIG. 8B is an expanded region near the dispensing surface of the shim shown in FIG. 8A.

FIG. 9 is a perspective assembly drawing of several different exemplary sequences of shims employing the shims of FIGS. 5A-8A for making exemplary coextruded polymeric articles described herein, including the layer, the wall, and the segments in a repeating arrangement as shown in FIGS. 1, 2, and 3.

FIG. 10 is a perspective view of the some of the sequence of shims of FIG. 9, further exploded to reveal some individual shims.

FIG. 11 is an exploded perspective view of an example of a mount suitable for an extrusion die composed of multiple repeats of the sequence of shims of FIGS. 9 and 10.

FIG. 12 is a perspective view of the mount of FIG. 11 in an assembled state.

FIG. 13 is an optical image of the cross-section of Example 1.

FIG. 14 is an optical image of the cross-section of Example 2.

FIG. 15 is an optical image of the cross-section of Example 3.

FIG. 16 is a schematic cross-sectional view of an exemplary article described herein.

### DETAILED DESCRIPTION

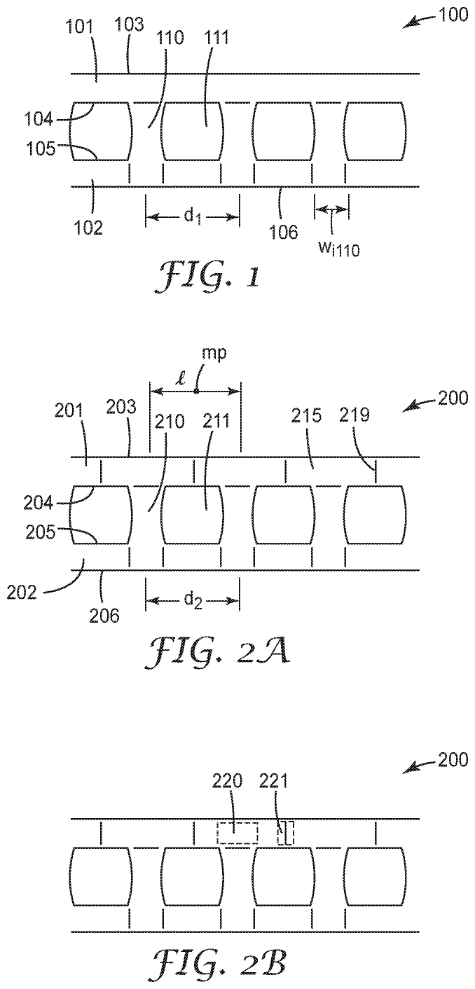

Referring to FIG. 1, exemplary first coextruded article described herein 100 comprises first and second layers 101, 102 each having first and second opposed major surfaces 103, 104, 105, 106. Between first and second layers 101, 102, series of walls 110 provides a series of microchannels 111. There are at least 10 first walls 110 per cm. There is an average minimum width for walls 110. The minimum width, wᵢ₁₁₀, of an individual wall 110 is within ±25 percent of the average minimum width, wₐ₁₁₀, for walls 110. Distance, d₁, measured from the respective midpoints of two walls, is used to express the number of walls in a given distance.

Referring to FIG. 2, exemplary second coextruded article described herein 200 comprises first and second layers 201, 202 each having first and second opposed major surfaces 203, 204, 205, 206. Between first and second layers 201, 202, series of walls 210 provides a series of microchannels 211. First layer 201 comprises segments 215. Each segment 215 is connected to a single wall 210. There is a line of demarcation line 219 between adjacent segments 215. There are at least 3 (or at least 5 or 10) walls 210 per cm. As shown, there is a length, l, along first layer between respective adjacent walls 210. For each length, l, there is a midpoint, mp. Line of demarcation 219 for respective adjacent walls 210 is at midpoint, mp. Distance, d₂, measured from the respective midpoints of two walls, is used to express the number of walls in a given distance. FIG. 2B shows coextruded article 200 with analytical regions 220 and 221 as reference positions to detect the demarcation line.

Referring to FIG. 3, exemplary third coextruded article described herein 300 comprises first and second opposed major surfaces 305, 306. Coextruded article 300 comprises layer 301, series of first walls 310, and segments 302. Layer 301 has first and second opposed major surfaces 303 and 304. First major surface of layer 303 and first major surface 305 of coextruded article 300 are the same major surface. Layer 301 comprises a first material. First walls 310 provide a series of microchannels 311 extending from second major surface 306 of layer 302. Each wall has distal end 307 with major surface 306. First walls 310 comprise a second material.

The terms “elastomeric properties” or “elastomer” refers to a resin material that can undergo a substantial elongation and then return to its original dimensions upon release of the stress elongating the elastomer. In some cases an elastomer is able to undergo at least 10% elongation (at a thickness of 0.5 mm), and return to at least 50% recovery after being held at that elongation for 2 seconds and after being allowed 1 minute relaxation time. In some examples, an elastomer can undergo 25% elongation without exceeding its elastic limit. In some examples elastomers can undergo elongation to as much as 300% or more of its original dimensions without tearing or exceeding the elastic limit of the composition.

Elastomers can be defined to reflect this elasticity as in ASTM Designation D833-96 as a macromolecular material that at room temperature returns rapidly to approximately its initial dimensions and shape after substantial deformation by a weak stress and release of the stress. ASTM Designation D883-96 as a macromolecular material that, at room temperature, returns rapidly to approximately its initial dimensions and shape after substantial deformation by a weak stress and release of the stress. ASTM Designation D412-98 A can be an appropriate procedure for testing rubber properties in tension to evaluate elastomeric properties.

The first walls 310 may comprise an elastomer, and first and second layers comprise a material different than an elastomer. In such an embodiment, first and second layers may be non-elastomers. In another embodiment, first walls 310 may comprise an elastomer and either the first or second or both the first and second layers may comprise an elastomer that is the same formulation or a different formulation form that of the first walls.

In some embodiments, the first walls comprise a thermoplastic material. In some embodiments the thermoplastic material is at least one of polyolefins, ethylene vinyl acetate polymers, polyurethanes, or styrene block copolymers (e.g., styrene-isoprene-styrene block copolymers), or polyurethanes or any such resin with elastomeric properties.

In some embodiments, the first layer comprises a non-elastomeric material and the second layer comprises an elastomeric material. In some embodiments, the walls comprise a thermoplastic material comprising an elastomer and at least the first and second layer comprise at least one thermoplastic material which is not an elastomer. In another embodiment, the first and second layers are either the same or different elastomers, and the walls are a non-elastomeric polyolefin. In another embodiment, the first layer is polyurethane, the walls are the same or a different elastomeric polyurethane, and the second layer is a non-elastomeric medium density polyethylene.

There are at least 3 (or at least 5 or 10) first walls per cm. Segments 302 comprising a third material. One of segments is positioned between two adjacent first walls 310. Segments 302 have first and second opposed major surfaces 311, 312. Second major surface 312 of segments 302, second major surface 306 of coextruded article 300, and major surface 307 of distal ends 319 of walls 310 are the same major surfaces. Third material is different from the second material. Distance, d₃, measured from the respective midpoints of two walls, is used to express the number of walls in a given distance.

In some embodiments of coextruded articles described herein, for the first layer there are lines of demarcation between adjacent walls. In some embodiments, there is a length along the first layer between respective adjacent walls, wherein for each length there is a midpoint, and wherein the line of demarcation for respective adjacent walls is at the midpoint. In some embodiments, for the second layer there are lines of demarcation between adjacent walls. In some embodiments, there is a length along the first layer between respective adjacent walls, wherein for each length there is a midpoint, and wherein the line of demarcation for respective adjacent walls is at the midpoint. A demarcation line or boundary region can be detected as described in the Examples using Differential Scanning calorimetry (DSC).

In general, the first layer, the wall, and the segments are joined together to form a continuous coextruded article at the distal slot of the die, and in this case also immediately after the melt exits the die, with microchannels formed between the outside surfaces. The article is extruded, similar to the way that plastic films are extruded. Thus, while the cross direction is composed of a combination of features the machine direction is uniform in structure and can continue for great length. The coextruded article in end use can be cut to short length dependent upon desired application.

The cavities, passageways, and orifices formed to create the layer, walls, and segments are formed from shims that are positioned next to each other. Some shims have slots cut to form the passageways. Other shims do not, which create the sidewalls of the passageways. The width of the passageways, and the walls created from adjacent shims are thus formed from the thickness dimension of the shimstock. Shimstock with uniform thickness is used to form these dies. Shimstock thickness can be obtained with thickness variation less than +/−5 micrometers. This precision in thickness enables precision in wall thickness, due to uniform passageway and orifice dimensions.

In some embodiments of coextruded articles described herein, there is an average minimum width for the first walls, wherein the width of an individual first wall is within ±25 (in some embodiments, ±20, ±15, ±10, or even ±5) percent of the average minimum width for the first walls.

In some embodiments of coextruded articles described herein, the microchannels have a width not greater than 500 (in some embodiment, not greater than 400, 300, 200, or even not greater than 100; in some embodiments, in a range from 300 to 400, 200 to 500, or even 100 to 500) micrometers.

In some embodiments of coextruded articles described herein, the walls have a height (i.e., between the first and second layers) not greater than 2000 (in some embodiments, not greater than 1500, 1000, 500, 250, or up to 100) in some embodiments, in a range from 50 to 2000, 100 to 2000, 200 to 1000, or even 300 to 500) micrometers.

In some embodiments of coextruded articles described herein, there are at least plurality of first walls having a width not greater than 400 (in some embodiment, not greater than 300, 200, or even not greater than 100; in some embodiments, in a range from 50 to 400, 50 to 300, 50 to 200, or even 50 to 100) micrometers. In some embodiments, coextruded articles described herein or parts thereof, can be foamed at different porosity levels using, for example, chemical foaming agents (CFA) (also sometimes referred to as chemical blowing agents (CBA)). The mechanical properties (e.g., compression behavior) of coextruded articles described can be tuned by selectively making some of the segments porous. Other approaches to affecting the mechanical properties of the coextruded articles include the quantity of CFA used and CFA activation temperature(s).

In some embodiments, CFAs are exothermic, in others endothermic. Exemplary exothermic CFAs include an azo-dicarbonamide and sulfonyl-hydrazide. Exemplary endothermic CFAs include sodium bicarbonate and citric acid, and available, for example, under the trade designation “HYDROCEROL BIH-40-E” from Clariant Corporation, Muttenz, Switzerland.

In some embodiments of coextruded articles described herein, at least one of the first or second layers are essentially free of closed-cell porosity (i.e., less than 5; in some embodiments, less than 4, 3, 2, or even less than 1) percent by volume closed-cell porosity based on the total volume of the respective layer) (in some embodiments, both the first or second layers are essentially free of closed-cell porosity). “Closed-cell porosity” refers to internal porosity that is not open through an outer surface of the coextruded article.

In some embodiments of coextruded articles described herein, at least a portion (in some embodiments, at least 5, 10, 15, 20, 25, 30, 35, 40, 45, 50, 55, 60, 65, 70, 75, 80, 85, 90, 95, 96, 97, 98, 99, or even 100 percent by number) of at least one of the first or second layers are essentially free of closed-cell porosity (i.e., less than 5; in some embodiments, less than 4, 3, 2, or even less than 1) percent by volume closed-cell porosity, based on the total volume of the respective wall).

In some embodiments of coextruded articles described herein, at least one of the first or second layers have a closed-cell porosity of at least 5 (in some embodiment, at least 10, 15, 20, 25, 30, 35, 40, 45, or even at least 50; in some embodiments, in a range from 5 to 90, 10 to 90, 25 to 90, 50 to 90, 60 to 90, 50 to 80, or even 60 to 80) percent by volume closed-cell porosity, based on the total volume of the respective layer).

In some embodiments of coextruded articles described herein, at least a portion (in some embodiments, at least 5, 10, 15, 20, 25, 30, 35, 40, 45, 50, 55, 60, 65, 70, 75, 80, 85, 90, 95, 96, 97, 98, 99, or even 100 percent by number) of the first walls have a closed-cell porosity of at least 5 (in some embodiment, at least 10, 15, 20, 25, 30, 35, 40, 45, 50, or even at least 50; in some embodiments, in a range from 5 to 90, 10 to 90, 25 to 90, 50 to 90, 60 to 90, 50 to 80, or even 60 to 80) percent by volume closed-cell porosity, based on the total volume of the respective wall.

In some embodiments of coextruded articles described herein, all walls between the first and second layers are the first walls. In some embodiments of coextruded articles described herein, further comprise a plurality of second walls. In some embodiments, the second walls have a minimum width not greater than 400 (in some embodiment, not greater than 300, 200, or even not greater than 100; in some embodiments, in a range from 50 to 400, 50 to 300, 50 to 200, or even 50 to 100) micrometers. In some embodiments, there is an average minimum width for the second walls, wherein the minimum width of an individual second wall is within ±25 (in some embodiments, ±20, ±15, ±10, or even ±5) for the second walls. In some embodiments, at least a portion (in some embodiments, at least 5, 10, 15, 20, 25, 30, 35, 40, 45, 50, 55, 60, 65, 70, 75, 80, 85, 90, 95, 96, 97, 98, 99, or even 100 percent by number) of the second walls are essentially free of closed-cell porosity. In some embodiments, at least a portion (in some embodiments, at least 5, 10, 15, 20, 25, 30, 35, 40, 45, 50, 55, 60, 65, 70, 75, 80, 85, 90, 95, 96, 97, 98, 99, or even 100 percent by number) of the second walls have a closed-cell porosity of at least 5 (in some embodiment, at least 10, 15, 20, 25, 30, 35, 40, 45, 50, or even at least 50; in some embodiments, in a range from 5 to 90, 10 to 90, 25 to 90, 50 to 90, 60 to 90, 50 to 80, or even 60 to 80) percent by volume closed-cell porosity, based on the total volume of the respective wall. In some embodiments of coextruded articles, all walls between the first and second layers are first and second walls. In some embodiments of coextruded articles described herein, all walls between the first and second layers are first walls.

A plurality of second walls that alternate with the first walls through the width of the coextruded article (i.e. wall profile taper—wider at an interface with the first layer, narrower at interface with the second layer) can be made by minor variations of the shim dispensing surface. The second walls can be made porous or made with a different material than the first wall, for example, to tune mechanical properties of the coextruded article.

An optional fourth cavity can be used to dispense material to create the second walls. The second wall can be dispensed close to the first wall to create a cojoined wall that is formed when two melt streams for the walls fuse together by die swell phenomena right after exiting the die. In some embodiments of a cojoined wall, one walls can contain functional particles, while the other is free of such particles and provides strengthening to the wall. In some embodiment, the functional particles (e.g., aluminum oxide, aluminum nitride, aluminum trihydrate, boron nitride, copper, graphite, graphene, magnesium oxide, zinc oxide) provide desired electrical or thermal properties to coextruded articles described herein.

In some embodiments of coextruded articles described herein, the microchannels have a length of at least 15 cm (in some embodiment, at least 20 cm, 25 cm, 30 cm, 50 cm, 1 m, 5 m, 10 m, 25 m, 50 m, or even at least 100 m).

In some embodiments of coextruded articles described herein, the first and second layers in independently comprise thermoplastic material (e.g., at least one of polyolefins, ethylene vinyl acetate polymers, polyurethanes, or styrene block copolymers (e.g., styrene-isoprene-styrene block copolymers). In some embodiments, a layer comprises more than one (e.g., a second, or even a third thermoplastic material).

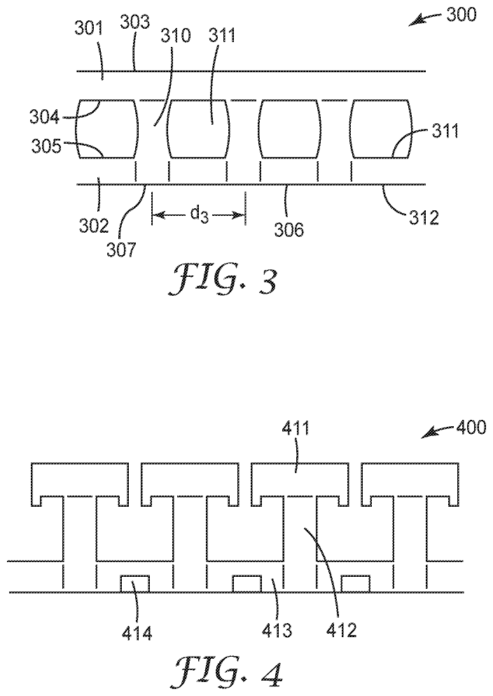

In some embodiments of coextruded articles described herein, there is adhesive in the segment between walls. This adhesive is fed from the optional fourth cavity orifice shown in FIG. 4. Exemplary adhesives include at least one of copolymers and blends thereof, an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive. In some embodiments, the adhesive is a pressure sensitive adhesive (PSA).

In some embodiments of coextruded articles described herein, the first layer comprises a first material, the segments comprise a second material, and the walls comprise a third material, wherein the third material is different from both the first and second materials. “Different” as used herein means at least one of (a) a difference of at least 2% in at least one infrared peak, (b) a difference of at least 2% in at least one nuclear magnetic resonance peak, (c) a difference of at least 2% in the number average molecular weight, or (d) a difference of at least 5% in polydispersity. Examples of differences in polymeric materials that can provide the difference between polymeric materials include composition, microstructure, color, and refractive index. The term “same” in terms of polymeric materials means not different.

In some embodiments of coextruded articles described herein, the first layer comprises a first material, the segments comprise a second material, and the walls comprise a third material, wherein at least two of the first material, the second material, or the third material are the same.

In some embodiments of coextruded articles described herein, the first layer comprises a first material, the segments comprise a second material, and the walls comprise a third material, wherein the first material, the second material, and the third material are the same.

In some embodiments of coextruded articles described herein, the first major surface of the first layer has functional particles thereon.

In some embodiments of coextruded articles described herein, the first layer has a thickness of at least 100 (in some embodiments, at least 150, 175, or even at least 200; in some embodiments, in a range from 100 to 300, 150 to 250, or even 200 to 250) micrometers. In some embodiments of coextruded articles described herein, the segments have a thickness of at least 100 (in some embodiments, at least 150, 175, or even at least 200; in some embodiments, in a range from 100 to 300, 150 to 250, or even 200 to 250) micrometers.

In some embodiments, coextruded articles described herein has a thickness of at least 300 (in some embodiments, at least 400, 500, 600, or even at least 700; in some embodiments, in a range from 300 to 2500, 300 to 2000, 400 to 1500, or even 500 to 1000) micrometers.

In some embodiments, a segment includes a region comprising a material different than other portions or regions of the segment. In some embodiments, the region comprising a material different than other portions or regions of the segment provides a portion of the second major surface of the segment.

Coextruded polymeric articles described herein (including those shown in FIGS. 1, 2, and 3), each of the layer, the walls, and respective segments may be considered monolithic (i.e., having a generally uniform composition) and are not fibrous. The coextruded articles formed are created from individual polymer melt streams which are bonded together to form one coextruded article in the distal slot. This is accomplished by formation of weld lines, called demarcation lines at the die region where the dispensing orifices merge together at the distal opening. Further, the coextruded articles are not nonwoven materials, nor are they assembled with coatings added via as a secondary step.

Exemplary coextruded articles described herein can be made, for by extrusion from a die. An exemplary has a variety of passageways from cavities within the die to a dispensing slot, including exemplary dies described herein (see, e.g., FIG. 4). The die may conveniently be comprised of a plurality of shims. In some embodiments, the plurality of shims comprises a plurality of sequences of shims that includes shims that the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims.

In some embodiments, the shims will be assembled according to a plan that provides a sequence of shims of diverse types. Since different applications may have different requirements, the sequences can have diverse numbers of shims. The sequence may be a repeating sequence that is not limited to a particular number of repeats in a particular zone. Or the sequence may not regularly repeat, but different sequences of shims may be used. The shape of the passageways within, for example, a sequence of shims, may be identical or different. Examples of passageway cross-sectional shapes include round, square, and rectangular shapes. In some embodiments, the shims that provide a passageway between one cavity and the dispensing slot might have a flow restriction compared to the shims that provide a passageway between another cavity and the dispensing slot. The width of the distal opening within, for example, a different sequence of shims, may be identical or different. For example, the portion of the distal opening provided by the shims that provide a passageway between one cavity and the dispensing slot could be narrower than the portion of the distal opening provided by the shims that provide a passageway between another cavity and the dispensing slot.

Individual cavities and passageways provide a conduit for polymer to orifices to create the first layer, the walls, and the segments region. These individual flowstreams merge together to form a continuous, solid polymeric coextruded article, at the die slot portion of the die. Spacer shims provide connecting slots to form demarcation lines connecting the first layer, the walls, and the segments.

In some embodiments, extrusion dies described herein include a pair of end blocks for supporting the plurality of shims. In these embodiments, it may be convenient for one, or even all, of the shims to each have at least one through-holes for the passage of connectors between the pair of end blocks. Bolts disposed within such through-holes are one convenient approach for assembling the shims to the end blocks, although the ordinary artisan may perceive other alternatives for assembling the extrusion die. In some embodiments, the at least one end block has an inlet port for introduction of fluid material into one, or both, of the cavities.

In some embodiments, the shims will be assembled according to a plan that provides a repeating sequence of shims of diverse types. The repeating sequence can have diverse numbers of shims per repeat. For a first example, a repeating sequence utilizing four shim types is described below to create the orifice pattern shown in FIG. 4 to create the polymeric coextruded articles shown in FIGS. 1-3. When that repeating sequence is properly provided with molten polymer, it extrudes a continuous film through the die slot to create the polymeric coextruded article with layers, walls, and segments.

In some embodiments, the assembled shims (conveniently bolted between the end blocks) further comprise a manifold body for supporting the shims. The manifold body has at least one (e.g., in some embodiments two three, four, or more) manifold therein, the manifold having an outlet. An expansion seal (e.g., made of copper or alloys thereof) is disposed to seal the manifold body and the shims, such that the expansion seal defines a portion of at least one of the cavities (in some embodiments, a portion of both the first and second cavities), and such that the expansion seal allows a conduit between the manifold and the cavity.

Typically, the passageway between cavity and dispensing orifice is up to 5 mm in length. Sometimes the fluid passageways leading to one array has greater fluid restriction than the fluid passageways leading to one or more of the other arrays.

The shims for dies described herein typically have thicknesses in the range from 50 micrometers to 125 micrometers, although thicknesses outside of this range may also be useful. Typically, the fluid passageways have thicknesses in a range from 50 micrometers to 750 micrometers, and lengths less than 5 mm (with generally a preference for smaller lengths for decreasingly smaller passageway thicknesses), although thicknesses and lengths outside of these ranges may also be useful. For large diameter fluid passageways, several smaller thickness shims may be stacked together, or single shims of the desired passageway width may be used.

The shims are tightly compressed to prevent gaps between the shims and polymer leakage. For example, 12 mm (0.5 inch) diameter bolts are typically used and tightened, at the extrusion temperature, to their recommended torque rating. Also, the shims are aligned to provide uniform extrusion. To aid in alignment, an alignment key can be cut into the shims. Also, a vibrating table can be useful to provide a smooth surface alignment of the extrusion tip.

In practicing methods described herein, the polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second and/or third polymeric materials are low molecular weight polymers that need to be cross-linked to be solidified, which can be done, for example, by electromagnetic or particle radiation. In some embodiments, it is desirable to maximize the time to quenching to increase the bond strength.

FIG. 4 is a schematic cross-sectional view of an exemplary die orifice pattern just upstream from the dispensing slot of the die employed in the formation of an exemplary polymeric coextruded article described herein. Orifice plan shows first orifices 411, second orifices 412, and third orifices 413. Also shown is optional fourth orifices 414. As will be described in detail later, the orifices are spaced apart to provide passageway sidewalls between passageways with the use of spacer shims. The individual flowstreams are merged together, with demarcation lines to form a continuous polymeric coextruded article in the final slot orifice of the die, not shown. The demarcation line formed in the first layer is formed after the polymer exits the die slot. There is a gap in the die slot such that the first layer distal slot is not continuous, but rather, has narrow breaks in the slot. Because these breaks are close together, the die swell of polymer created as the polymer exits the die slot joins together adjacent orifice slots of the first layer, creating a continuous first layer with demarcation lines.

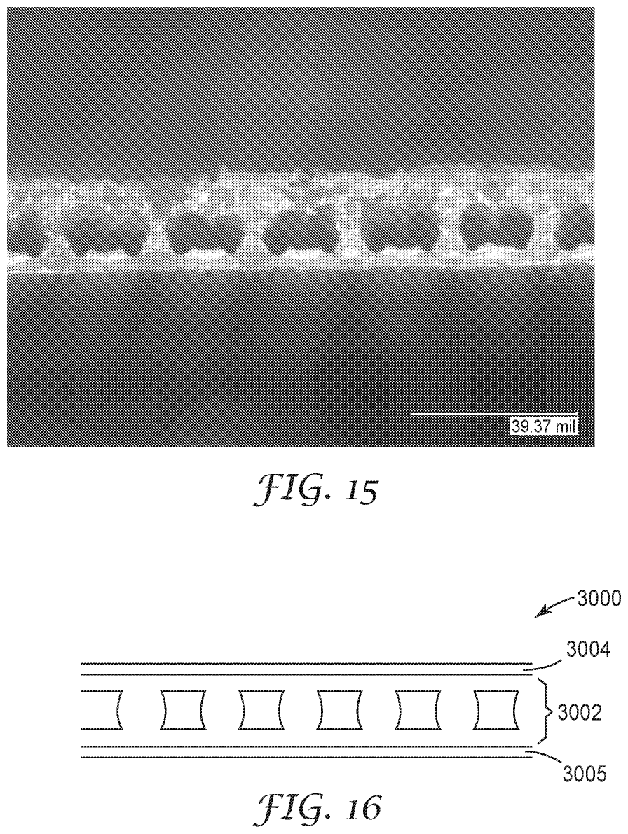

FIG. 16 shows article 3000, having pressure sensitive adhesive layer 3004 and 3005 on opposing major sides of the coextruded article 3002. The coextruded article 3002 may comprise constructions associate with coextruded articles 100, 200, 300, and 400, above.

Herein, a pressure sensitive adhesive (PSA) is used in its conventional manner according to the Pressure-Sensitive Tape Council, which states that PSAs are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). Central to all PSAs is a desired balance of adhesion and cohesion that is often achieved by optimizing the physical properties of the elastomer, such as glass transition temperature and modulus. For example, if the glass transition temperature (T_{g}) or modulus of the elastomer is too high and above the Dahlquist criterion for tack (storage modulus of 3×10⁶ dynes/cm² at room temperature and oscillation frequency of 1 Hz), the material will not be tacky and is not useful by itself as a PSA material.

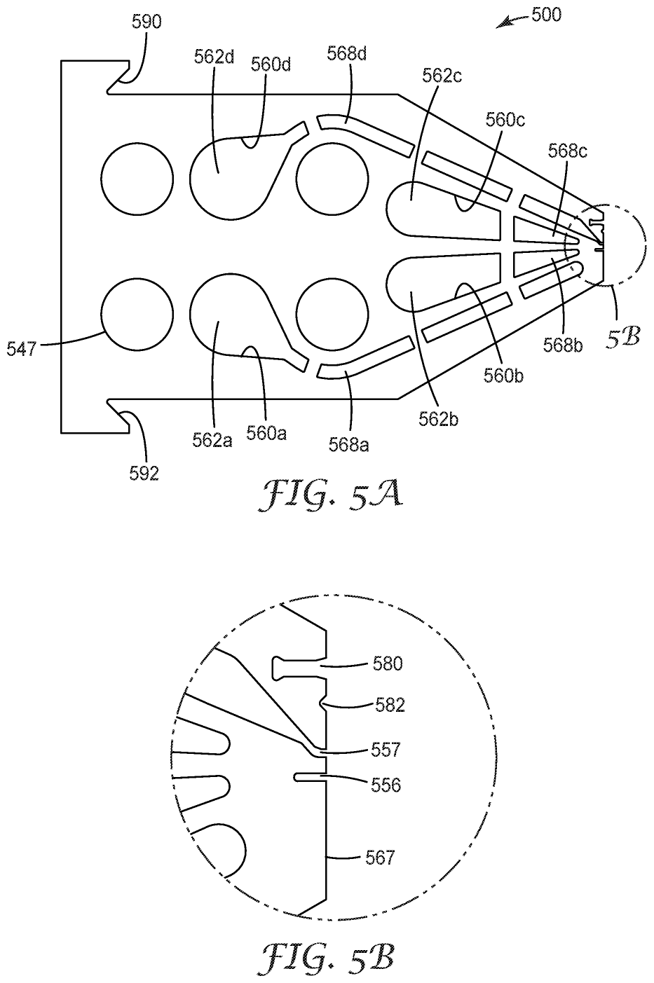

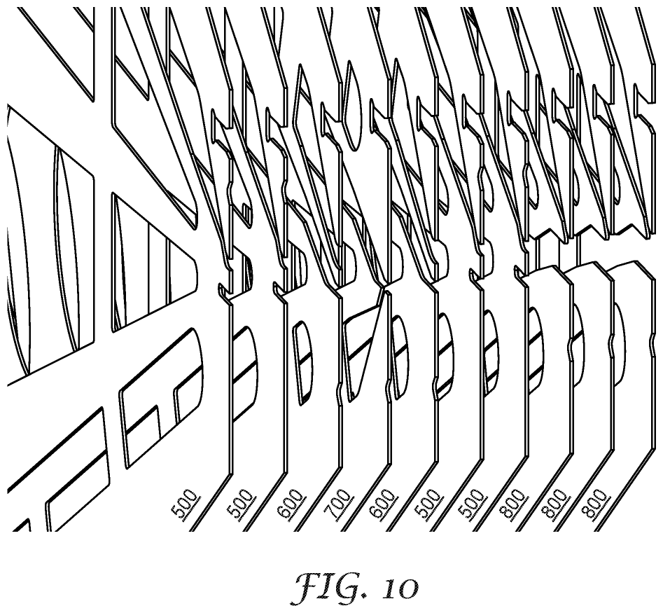

Referring now to FIGS. 5A, and 5B, a plan view of shim 500 is illustrated. Shim 500 has first aperture 560a, second aperture 560b third aperture 560c, and fourth aperture 560d. When shim 500 is assembled with others as shown in FIGS. 9 and 10, aperture 560a aids in defining first cavity 562a, aperture 560b aids in defining second cavity 562b, aperture 560c aids in defining third cavity 562c, and aperture 560d aids in defining third cavity 562d. Passageways 568a, 568b, 568c, and 568d cooperate with analogous passageways on adjacent shims to allow passage from cavities 562a, 562b, 562c, and 562d to the dispensing surfaces of the appropriate shims when the shims are assembled as shown in FIGS. 9 and 10.

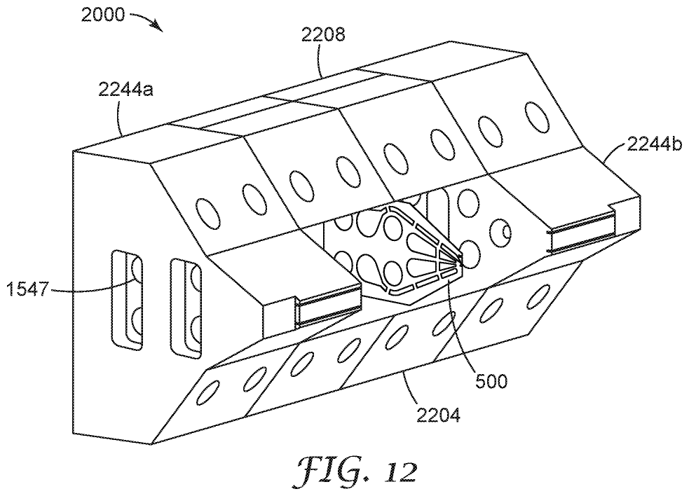

Shim 500 has several holes 547 to allow the passage of, for example, bolts, to hold shim 500 and others to be described below into an assembly. Shim 500 also has dispensing surface 567, and in this particular embodiment, dispensing surface 567 has indexing groove 580 which can receive an appropriately shaped key to ease assembling diverse shims into a die. The shim may also have identification notch 582 to help verify that the die has been assembled in the desired manner. This embodiment has shoulders 590 and 592 which can assist in mounting the assembled die with a mount of the type shown in FIG. 12. Shim 500 has dispensing opening 556, but it will be noted that this shim has no connection between dispensing opening 556 and any of cavities 562a, 562b, 562c, or 562d. Shim 500 also has dispensing opening 557 with a connecting passageway to cavity 562d. Opening 557 forms a part of the segment. Opening 556 forms part of the first layer. Opening 556 provides a continuous dispensing slot for extrusion. This continuous slot enables polymer streams to merge together to form demarcation lines in the polymeric coextruded article between die orifices.

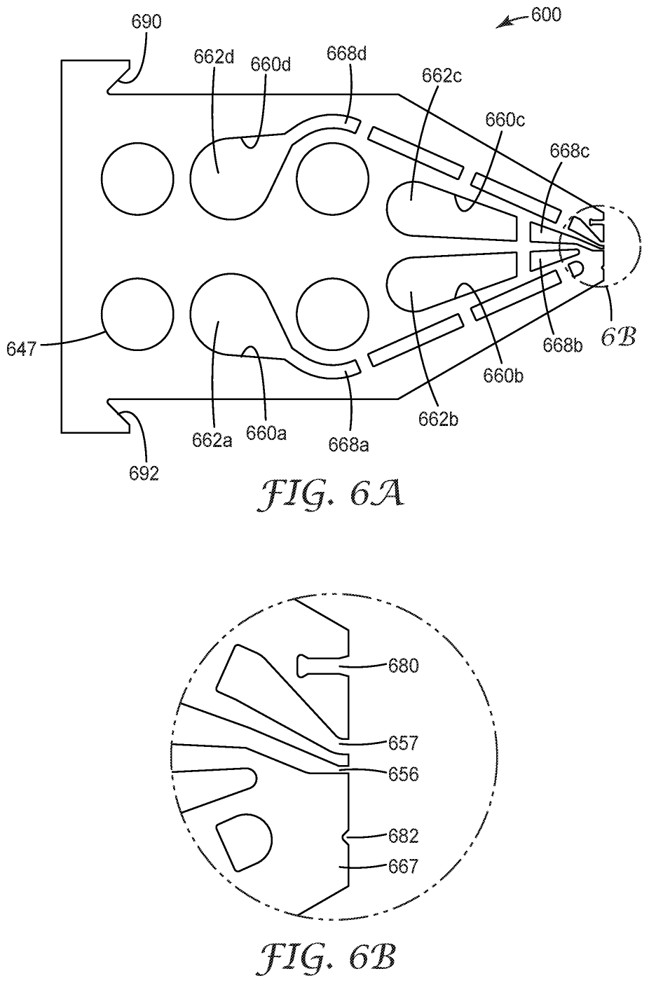

Referring to FIGS. 6A, and 6B, a plan view of shim 600 is illustrated. Shim 600 has first aperture 660a, second aperture 660b, third aperture 660c, and fourth aperture 660d. When shim 600 is assembled with others as shown in FIGS. 9 and 10, aperture 660a aids in defining first cavity 662a, aperture 660b aids in defining second cavity 662b, aperture 660c aids in defining third cavity 662c, and aperture 660d aids in defining third cavity 662d. Passageways 668a, 668b, 668c, and 668d cooperate with analogous passageways on adjacent shims to allow passage from cavities 662a, 662b, 662c, and 662d to the dispensing surfaces of the appropriate shims when the shims are assembled as shown in FIGS. 9 and 10.

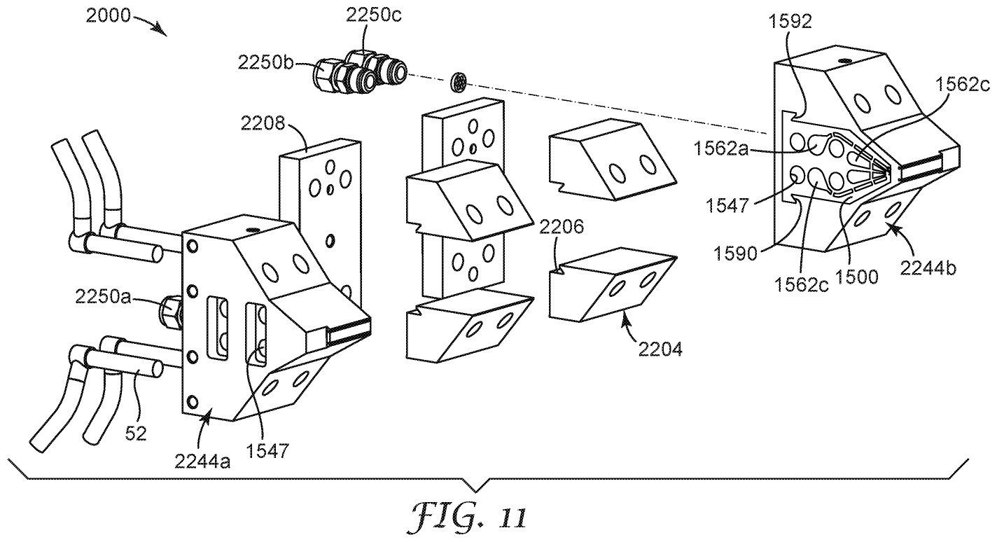

Shim 600 has several holes 647 to allow the passage of, for example, bolts, to hold shim 600 and others to be described below into an assembly. Shim 600 also has dispensing surface 667, and in this particular embodiment, dispensing surface 667 has indexing groove 680 which can receive an appropriately shaped key to ease assembling diverse shims into a die. The shim may also have identification notch 682 to help verify that the die has been assembled in the desired manner. This embodiment has shoulders 690 and 692 which can assist in mounting the assembled die with a mount of the type shown in FIG. 11. Shim 600 has dispensing opening 656, in dispensing surface 667. Dispensing opening 656 may be more clearly seen in the expanded view shown in FIG. 6B. It might seem that there is no path from cavity 662c to dispensing opening 656, via, for example, passageway 668c, but the flow has a route in the perpendicular-to-the-plane-of-the-drawing dimension when the sequence of FIG. 6 is completely assembled. Shim 600 also has dispensing opening 657, with connection to cavity 662d. Opening 656 forms a portion of the segment, opening 657 forms a portion of the layer.

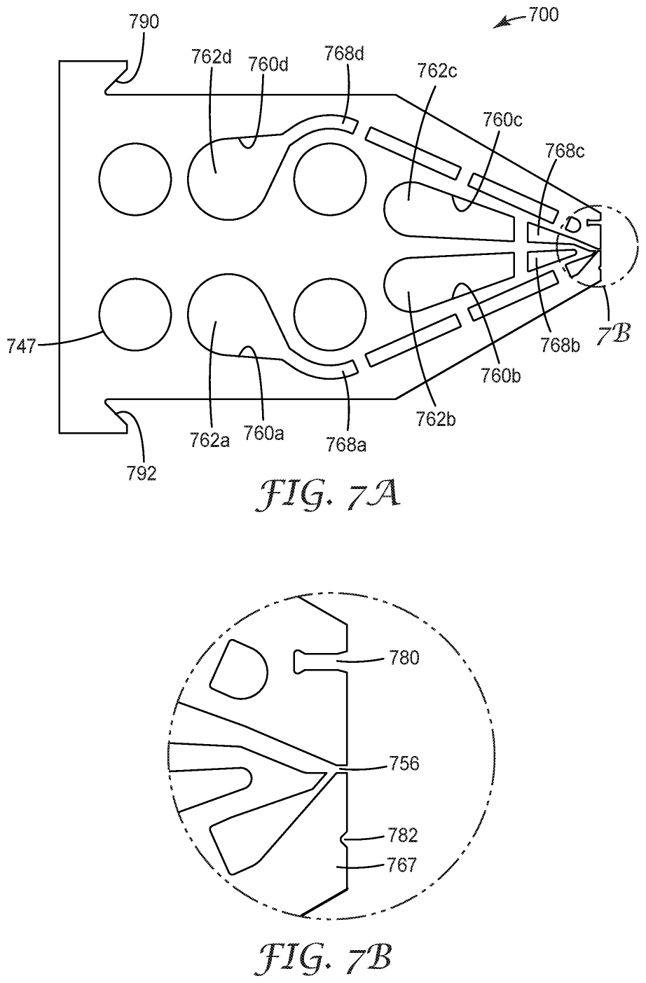

Referring to FIGS. 7A, and 7B, a plan view of shim 700 is illustrated. Shim 700 has first aperture 760a, second aperture 760b, third aperture 760c, and fourth aperture 760d. When shim 700 is assembled with others as shown in FIGS. 9 and 10, aperture 760a aids in defining first cavity 762a, aperture 760b aids in defining second cavity 762b, aperture 760c aids in defining third cavity 762c, and aperture 760d aids in defining third cavity 762d. Passageways 768a, 768b, 768c, and 768d cooperate with analogous passageways on adjacent shims to allow passage from cavities 762a, 762b, 762c, and 762d to the dispensing surfaces of the appropriate shims when the shims are assembled as shown in FIGS. 9 and 10.

Shim 700 has several holes 747 to allow the passage of, for example, bolts, to hold shim 700 and others to be described below into an assembly. Shim 700 also has dispensing surface 767, and in this particular embodiment, dispensing surface 767 has indexing groove 780 which can receive an appropriately shaped key to ease assembling diverse shims into a die. The shim may also have identification notch 782 to help verify that the die has been assembled in the desired manner. This embodiment has shoulders 790 and 792 which can assist in mounting the assembled die with a mount of the type shown in FIG. 12. Shim 700 has dispensing opening 756, with connection to cavities 762a, and also 762c. Shim 700 forms a portion of the wall and also the layer.

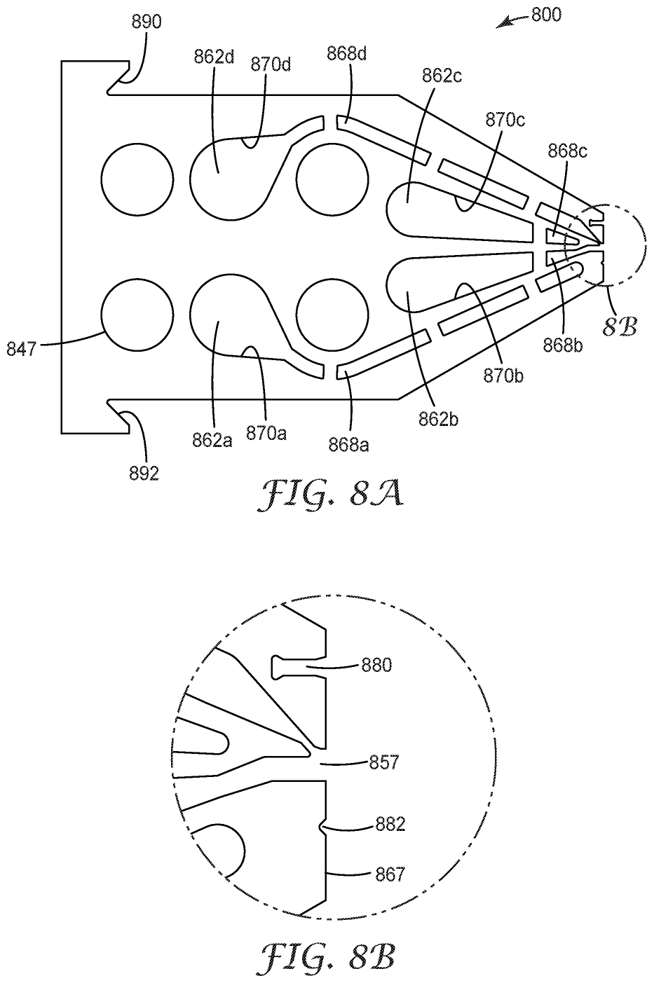

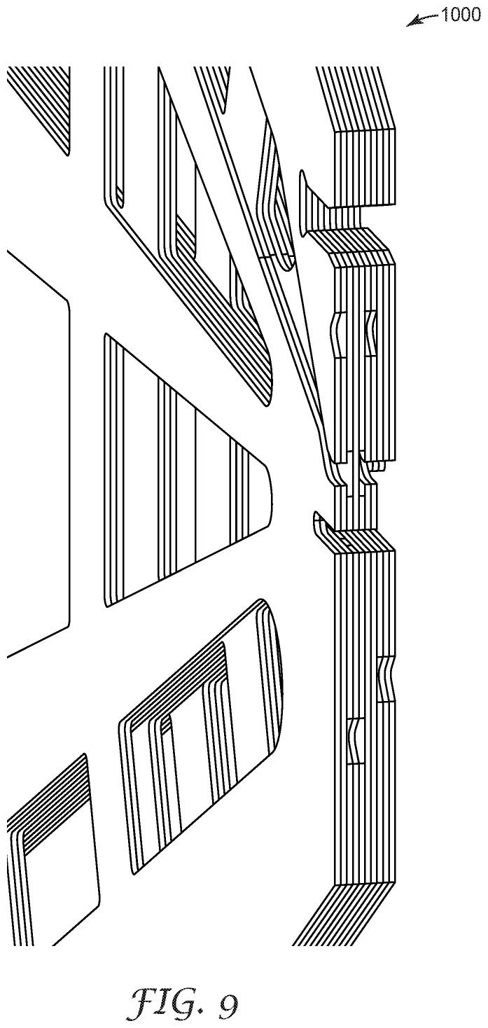

Referring to FIGS. 8A, and 8B, a plan view of shim 800 is illustrated. Shim 800 has first aperture 860a, second aperture 860b, third aperture 860c, and fourth aperture 860d. When shim 800 is assembled with others as shown in FIGS. 9 and 10, aperture 860a aids in defining first cavity 862a, aperture 860b aids in defining second cavity 862b, aperture 860c aids in defining third cavity 862c, and aperture 860d aids in defining third cavity 862d. Passageways 868a, 868b, 868c, and 868d cooperate with analogous passageways on adjacent shims to allow passage from cavities 862a, 862b, 862c, and 862d to the dispensing surfaces of the appropriate shims when the shims are assembled as shown in FIGS. 9 and 10.

Shim 800 has several holes 847 to allow the passage of, for example, bolts, to hold shim 800 and others to be described below into an assembly. Shim 800 also has dispensing surface 867, and in this particular embodiment, dispensing surface 867 has indexing groove 880 which can receive an appropriately shaped key to ease assembling diverse shims into a die. The shim may also have identification notch 882 to help verify that the die has been assembled in the desired manner. This embodiment has shoulders 890 and 892 which can assist in mounting the assembled die with a mount of the type shown in FIG. 12. Shim 800 has dispensing opening 857, in dispensing surface 867. Dispensing opening 857 may be more clearly seen in the expanded view shown in FIG. 8B. It might seem that there is no path from cavity 862d and 862b to dispensing opening 857, via, for example, passageway 868d and 868b, but the flow has a route in the perpendicular-to-the-plane-of-the-drawing dimension when the sequence of FIG. 9 is completely assembled.

Referring to FIG. 9, a perspective assembly drawing of a several different repeating sequences of shims, collectively 1000, employing the shims of FIGS. 5-8 so as to be able to produce polymeric coextruded article 100 shown in FIGS. 1, 200 in FIG. 2, and coextruded article 300 in FIG. 3 is shown. It should be noted in FIG. 9 that the dispensing slot, formed by dispensing openings 556, 557, 656, 657, 756, 857, collectively in the plurality of shims, is a continuous opening across the die. This continuous opening is fed from a plurality of the three extrusion orifices as shown in FIG. 4. It should also be noted that the layer portion of the coextruded article is formed by dispensing openings 557, 657, and 856, but that there is no opening for shim 700 for the layer section. In this case the demarcation in the coextruded article is formed with shim 700 providing the merge point for the layer orifices. The shim thickness of 700 is kept to a minimum, such as 100 micrometers or less in thickness, such that the demarcation line is successfully formed.

Referring to FIG. 10, an exploded perspective assembly drawing of a repeating sequence of shims employing the shims of FIGS. 5-8 is illustrated. In the particular illustrated embodiment, the repeating sequence includes, from bottom to top as the drawing is oriented, three instances of shim 800, two instances of shim 500, one instance of shim 600, one instance of shim 700, one instance of shim 600, two instances of shim 500. In this view, it can be appreciated how the three orifices are merged together at the extrusion slot to generate a continuous a polymeric coextruded article. In this sequence, it is also apparent that there is an additional passageway with shim 700 to a fourth cavity. This is an optional feature, that provides additional flexibility towards the segment section.

Referring to FIG. 11, an exploded perspective view of a mount 2000 suitable for an extrusion die composed of multiple repeats of the repeating sequence of shims of FIGS. 9 and 10 is illustrated. Mount 2000 is particularly adapted to use shims 500, 600, 700, and 800 as shown in FIGS. 5-8. For visual clarity, however, only a single instance of shims is shown in FIG. 11. The multiple repeats of the repeating sequence of shims of FIGS. 9 and 10 are compressed between two end blocks 2244a and 2244b. Conveniently, through bolts can be used to assemble the shims to end blocks 2244a and 2244b, passing through holes 547 in shims 500 et al.

In this embodiment, inlet fittings provide a flow path for three streams of molten polymer through end blocks 2244a and 2244b to cavities 562a, 562b, and 562c, and 562d. Compression blocks 2204 have notch 2206 that conveniently engages the shoulders on shims (e.g., 590 and 592) on 500. When mount 2000 is completely assembled, compression blocks 2204 are attached by, for example, machine bolts to backplates 2208. Holes are conveniently provided in the assembly for the insertion of cartridge heaters 52.

Referring to FIG. 12, a perspective view of the mount 2000 of FIG. 11 is illustrated in a partially assembled state. A few shims, for example, 500 are in their assembled positions to show how they fit within mount 2000, but most of the shims that would make up an assembled die have been omitted for visual clarity.

Methods to make specific coextruded articles described herein may involve use of particular materials (e.g., same, different, or a combination thereof first, second and third materials). Example methods for making coextruded articles described herein include the following.

First coextruded articles described herein can be made for example, by a method comprising:

providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims;

providing via extrusion a first material to the first cavity of the extrusion die, a second material to the second cavity of the extrusion die, and a third material to the third cavity of the extrusion die;

extruding the layer from the distal opening of the die slot; and

quenching the extruded layer.

Second coextruded articles described herein can be made for example, by a method comprising:

providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims; wherein together these shims form a repeating orifice pattern of shims;

providing via extrusion a first material to the first cavity of the extrusion die, a second material to the second cavity of the extrusion die, and a third material to the third cavity of the extrusion die;

extruding the layer from the distal opening of the die slot; and

quenching the extruded layer.

Third coextruded articles described herein can be made for example, by a method comprising:

providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims; wherein together these shims form a repeating orifice pattern of shims;

providing via extrusion a first material to the first cavity of the extrusion die, a second material to the second cavity of the extrusion die, and a third material to the third cavity of the extrusion die;

extruding the layer from the distal opening of the die slot; and

quenching the extruded layer.

Embodiment of coextruded articles described herein are useful, for example, in cushioning applications where high levels of compression are desired. Conventional foamed sheets are typically limited in the amount of void space that can be generated, whereas embodiments of coextruded articles described herein can have relatively high void content (i.e., greater than 50%).

Embodiments of coextruded articles described herein are useful, for example, in applications using liquid or gas materials for heat transfer. For example, a coextruded article described herein can be placed in contact with components requiring temperature control, wherein the channels contain heat transfer media.

Embodiments of coextruded articles described herein may also be used as spacer webs. For example, coextruded articles described herein can provide significant spacing with a minimal amount of material usage. For example, coextruded articles which require beam strength with minimal weight can be created with rigid films separated by a coextruded article described herein.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example 1

A co-extrusion die as generally depicted in FIGS. 11 and 12 was assembled with a multi shim repeating pattern of extrusion orifices as generally illustrated in FIGS. 9 and 10. The thickness of the shims in the repeat sequence was 4 mil (0.102 mm) for shims 800, 800, 800, 500, 500, 600, 700, 600, 500, and 500. The extrusion orifices were aligned in a collinear, alternating arrangement. The total width of the shim setup was about 10 cm (4 inches).

The inlet fittings on the two end blocks were each connected to four conventional single-screw extruders. The extruders feeding the four cavities were loaded with a styrene-isoprene-styrene (SIS) copolymer (obtained under the trade designation “VECTOR 4411A” from TSRC-Dexco Corporation, Kaohsiung City, Taiwan ROC). The SIS copolymer for the first cavity was dry blended with 1 wt. % chemical foaming agent (obtained under the trade designation “HYDROCEROL BIH-40-E” from Clariant Corporation, Muttenz, Switzerland) and 2 wt. % yellow color concentrate (obtained under the trade designation “10038103” from PolyOne Distribution, Romeoville, Ill.). The SIS copolymer for the second cavity was dry blended with 1 wt. % chemical foaming agent (“HYDROCEROL BIH-40-E”) and 2 wt. % blue color concentrate (obtained under the trade designation “PP54643779” from Clariant). The SIS copolymer for the third cavity was dry blended with 2 wt. % orange color concentrate (obtained under the trade designation “PP23642905” from Clariant). The SIS copolymer for the fourth cavity was dry blended with 1 wt. % chemical foaming agent (“HYDROCEROL BIH-40-E”) and 2 wt. % white color concentrate (obtained under the trade designation “1015100S” from Clariant). An optical image of the cross-section of Example 1 is shown in FIG. 13.

The melt was extruded vertically into an extrusion quench takeaway. The quench roll was a smooth temperature controlled chrome plated 20-cm diameter steel roll. The quench temperature was controlled with internal water flow. The web path wrapped 180 degrees around the chrome steel roll and then to a windup roll.

Other process conditions are listed below:

| | |
|---|---|
| Flow rate of first polymer (first layer) | 11.3 kg/hr. |
| Flow rate of second polymer (wall) | 3.7 kg/hr. |
| Flow rate of third polymer (segment) | 0.2 kg/hr. |
| Flow rate of optional fourth polymer | 2.3 kg/hr. |
| Extrusion temperature | 191° C. |
| Quench roll temperature | 16° C. |
| Quench takeaway speed | 4 m/min. |

An optical microscope was used to measure the film profile in cross-sectional direction resulting in the following measurements:

| Overall film caliper | 943 micrometers |
|---|---|
| Wall repeat length | 738 micrometers |
| First layer thickness | 314 micrometers |
| Segment thickness | 236 micrometers |
| Number of walls per cm | 12 |

An optical image of the cross-section of Example 1 is shown in FIG. 13. The demarcation lines (or weld lines) formed when the melt streams merged together after exiting the die were detected when the Example 1 coextruded article was analyzed using a differential scanning calorimeter (obtained under the trade designations “TA INSTRUMENTS Q2000 MODULATED DIFFERENTIAL SCANNING CALORIMETER” (MDSC) (SN #130, Cell RC-03761) and “TA DISCOVERY DSC” from TA instruments, New Castle, Del.) utilizing a heat-cool-heat method in temperature modulated mode (−80 to 190° C. at 4° C./min., with a modulation amplitude of ±0.636° C., and a period of 60 seconds). After data collection, the thermal transitions were compared using software (obtained under the trade designation “TA UNIVERSAL ANALYSIS” from TA instruments, New Castle, Del.).

Regions 221 and 220 as shown in the FIG. 2B were analyzed in the DSC. By using DSC measurements to compare temperature modulations, a region containing mostly a demarcation line (221) versus a region that did not substantially contain material from the demarcation line (220) could be evidenced by a difference in heat flow/heat capacity consistent with an energy release or reduction in molecular orientation/internal stress, leading to evidence of a demarcation line. That is, the thermal signatures of the regions analyzed were observed to have a combination of material thermal transitions and the material response to retained thermal/processing history. During sample preparation for Region 220, care was taken to cut the sample in a substantially parallel direction to the demarcation line in a region free of demarcation line material. A demarcation line was detected.

### Example 2

A co-extrusion die as generally depicted in FIGS. 11 and 12 was assembled with a multi shim repeating pattern of extrusion orifices as generally illustrated in FIGS. 9 and 10. The thickness of the shims in the repeat sequence was 4 mil (0.102 mm) for shims 800, 800, 800, 500, 500, 600, 700, 600, 500, and 500. The extrusion orifices were aligned in a collinear, alternating arrangement. The total width of the shim setup was about 10 cm (4 inches).

The inlet fittings on the two end blocks were each connected to four conventional single-screw extruders. The extruders feeding the four cavities were loaded with a styrene-isoprene-styrene (SIS) copolymer (“VECTOR 4411A”). The SIS copolymer for the first cavity was dry blended with 1 wt. % chemical foaming agent (“HYDROCEROL BIH-40-E”) and 2 wt. % yellow color concentrate (“10038103”). The SIS copolymer for the second cavity was dry blended with 1 wt. % chemical foaming agent (“HYDROCEROL BIH-40-E”) and 2 wt. % blue color concentrate (“PP54643779”). The SIS copolymer for the third cavity was dry blended with 2 wt. % orange color concentrate (“PP23642905”). The SIS copolymer for the fourth cavity was dry blended with 2 wt. % white color concentrate (“1015100S”).

The melt was extruded vertically into an extrusion quench takeaway. The quench roll was a smooth temperature controlled chrome plated 20 cm diameter steel roll. The quench temperature was controlled with internal water flow. The web path wrapped 180 degrees around the chrome steel roll and then to a windup roll.

Other process conditions are listed below:

| | |
|---|---|
| Flow rate of first polymer (first layer) | 11.5 kg/hr. |
| Flow rate of second polymer (wall) | 3.8 kg/hr. |
| Flow rate of third polymer (segment) | 0.3 kg/hr. |
| Flow rate of optional fourth polymer | 2.8 kg/hr. |
| Extrusion temperature | 191° C. |
| Quench roll temperature | 16° C. |
| Quench takeaway speed | 5.2 m/min. |

An optical microscope was used to measure the film profile in cross-sectional direction resulting in the following measurements:

| Overall film caliper | 737 micrometers |
|---|---|
| Wall repeat length | 591 micrometers |
| First layer thickness | 282 micrometers |
| Segment thickness | 133 micrometers |
| Number of walls per cm | 17 |

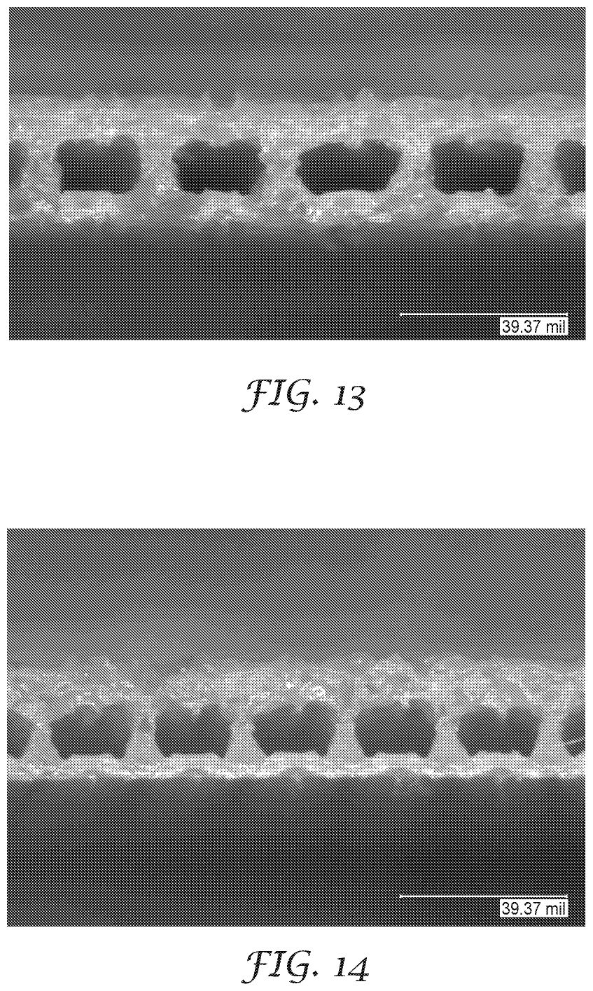

An optical image of the cross-section of Example 1 is shown in FIG. 14.

The Example 2 coextruded article was analyzed with the DSC as described in Example 1. A demarcation line was detected.

### Example 3

A co-extrusion die as generally depicted in FIGS. 11 and 12 was assembled with a multi shim repeating pattern of extrusion orifices as generally illustrated in FIGS. 9 and 10. The thickness of the shims in the repeat sequence was 4 mil (0.102 mm) for shims 800, 800, 800, 500, 500, 600, 700, 600, 500, and 500. The extrusion orifices were aligned in a collinear, alternating arrangement. The total width of the shim setup was about 10 cm (4 inches).

The inlet fittings on the two end blocks were each connected to four conventional single-screw extruders. The extruders feeding the four cavities were loaded with a styrene-isoprene-styrene (SIS) copolymer (“VECTOR 4411A”). The SIS copolymer for the first cavity was dry blended with 1 wt. % chemical foaming agent (“HYDROCEROL BIH-40-E”) and 2 wt. % yellow color concentrate (“10038103”). The SIS copolymer for the second cavity was dry blended with 1 w.t % chemical foaming agent (“HYDROCEROL BIH-40-E”) and 2 wt. % blue color concentrate (“PP54643779”). The SIS copolymer for the third cavity was dry blended with 2 wt. % orange color concentrate (“PP23642905”). The SIS copolymer for the fourth cavity was dry blended with 2 wt. % white color concentrate (“101500S”).

The melt was extruded vertically into an extrusion quench takeaway. The quench roll was a smooth temperature controlled chrome plated 20-cm diameter steel roll. The quench temperature was controlled with internal water flow. The web path wrapped 180 degrees around the chrome steel roll and then to a windup roll.

Other process conditions are listed below:

| | |
|---|---|
| Flow rate of first polymer (first layer) | 11.8 kg/hr. |
| Flow rate of second polymer (wall) | 3.7 kg/hr. |
| Flow rate of third polymer (segment) | 0.3 kg/hr. |
| Flow rate of optional fourth polymer | 2.9 kg/hr. |
| Extrusion temperature | 191° C. |
| Quench roll temperature | 16° C. |
| Quench takeaway speed | 7.6 m/min. |

An optical microscope was used to measure the film profile in cross-sectional direction resulting in the following measurements:

| Overall film caliper | 599 micrometers |
|---|---|
| Wall repeat length | 509 micrometers |
| First layer thickness | 235 micrometers |
| Segment thickness | 112 micrometers |
| Number of walls per cm | 20 |

An optical image of the cross-section of Example 1 is shown in FIG. 15.

The Example 3 coextruded article was analyzed with the DSC as described in Example 1. A demarcation line was detected.

Foreseeable modifications and alterations of this disclosure will be apparent to those skilled in the art without departing from the scope and spirit of this invention. This invention should not be restricted to the embodiments that are set forth in this application for illustrative purposes.

1. A coextruded article comprising:
coextruded first and second layers each having first and second opposed major surfaces;
between the first and second layers a series of first walls providing a series of microchannels; and
a first layer of pressure sensitive adhesive adjacent the first opposed major surface of the first layer, wherein there are at least 3 first walls per centimeter, and wherein there is an average minimum width for the first walls, and wherein a minimum width of an individual first wall is within ±25 percent of the average minimum width for the first walls.

2. The coextruded article of claim 1, wherein for the first layer there are lines of demarcation between adjacent walls.

3. The coextruded article of claim 1, wherein the microchannels have a width not greater than 500 micrometers.

4. The coextruded article of claim 1, wherein the walls have a height not greater than 2000 micrometers.

5. The coextruded article of claim 1, wherein at least one of the first or second layers are essentially free of closed-cell porosity.

6. A method of making the coextruded article of claim 1, the method comprising:
providing an extrusion die comprising a plurality of shims positioned adjacent to one another, the shims together defining a first cavity, a second cavity, a third cavity, and optionally a fourth cavity, and a die slot, wherein the die slot has a distal opening, wherein the die slot is comprised of a first plurality of orifices, a second plurality of orifices, and a third plurality of orifices, wherein the plurality of shims comprises a first plurality of a repeating sequence of shims that together provide a fluid passageway between the first cavity and a first orifice, and also together provide a fluid passageway between the second cavity and a second orifice, a second plurality of a repeating sequence of shims that together provide a fluid passageway between the third cavity and a third orifice, and a third plurality of shims that together provide a fluid passageway between the first cavity and a first orifice, and also together provide a fluid passageway between the third cavity and a third orifice, wherein together these shims form a repeating orifice pattern of shims;
providing via extrusion a first material to the first cavity of the extrusion die, a second material to the second cavity of the extrusion die, and a third material to the third cavity of the extrusion die;
extruding the first layer from the distal opening of the die slot;
quenching the extruded first layer; and,
coating one side of the extruded first layer with the first layer of pressure sensitive adhesive.

7. A coextruded article comprising first and second coextruded layers each having first and second opposed major surfaces and between the first and second layers a series of coextruded first walls providing a series of microchannels, wherein the first layer comprises segments, each segment being connected to a single wall, wherein there is a line of demarcation line between adjacent segments, and wherein there are at least 3 first walls per centimeter.

8. The coextruded article of claim 7, wherein there is a length along the first layer between respective adjacent walls, wherein for each length there is a midpoint, and wherein the line of demarcation for respective adjacent walls is at the midpoint.

9. The coextruded article of claim 7, wherein the microchannels have a width not greater than 500 micrometers.

10.-13. (canceled)

14. The coextruded article of claim 7, wherein the walls have a height not greater than 2000 micrometers.

15. (canceled)

16. The coextruded article of claim 7, wherein at least one of the first or second layers are essentially free of closed-cell porosity.

17. The coextruded article of claim 7, wherein at least one of the first or second layers have a closed-cell porosity of at least five percent by volume, based on the total volume of the at least one of the first or second layers, respectively.

18. The coextruded article of claim 7, wherein the first walls comprise an elastomer.

19. The coextruded article of claim 7, wherein the first walls comprise an elastomer, and the first and second layer comprise a material different from the elastomer.

20. The coextruded article of claim 1, wherein the first layer comprises segments, each segment being connected to a single wall, wherein there is a line of demarcation line between adjacent segments.

21. The coextruded article of claim 20, wherein there is a length along the first layer between respective adjacent walls, wherein for each length there is a midpoint, and wherein the line of demarcation for respective adjacent walls is at the midpoint.

22. The coextruded article of claim 1, further comprising a second layer of pressure sensitive adhesive adjacent the second opposed major surface of the second layer.

23. The coextruded article of claim 1, wherein at least one of the first or second layers have a closed-cell porosity of at least five percent by volume, based on the total volume of the at least one of the first or second layers, respectively.

24. The coextruded article of claim 1, wherein the first walls comprise an elastomer.

25. The coextruded article of claim 1, wherein the first walls comprise an elastomer, and the first and second layer comprise a material different from the elastomer.
